(19) United States
(12) Patent Application Publication
(10) Pub. No.: US 2023/0256986 A1
(43) Pub. Date: Aug. 17, 2023

(54) ELECTRIC VEHICLE AUTONOMOUS COPILOT FOR ENERGY USAGE OPTIMIZATION

(71) Applicant: Wireless Advanced Vehicle Electrification, LLC, Salt Lake City, UT (US)

(72) Inventor: David Greenfader, Rancho Palos Verdes, CA (US)

(21) Appl. No.: 17/674,267

(22) Filed: Feb. 17, 2022

(51) Int. Cl. B60W 50/14; B60W 20/20; B60W 30/18

(52) U.S. Cl. CPC B60W 50/14; B60W 20/20; B60W 30/18109; B60W 2050/143

(57) ABSTRACT

Described herein are techniques for generating and providing feedback to an operator of a vehicle in real-time to optimize operation of that vehicle. Such techniques may involve receiving, from a vehicle, operation data related to performance of one or more operations of the vehicle, obtaining expected operation data relevant to the vehicle, calculating a variance representing a difference between the between the operation data and the expected operation data, generating, based on the calculated variance, feedback to be provided to an operator of the vehicle, and providing the feedback to the vehicle to be presented to the operator.

### BACKGROUND

As the world becomes more aware of the impact that the use of fossil fuels is having on the environment, the demand for environmentally friendly alternatives is increasing. In the realm of transportation, vehicles that are powered by fossil fuels are being replaced by alternatives including partially or fully electric vehicles. In some cases, entire fleets of vehicles, such as busses, are being replaced by electric vehicles. However, despite this increase in popularity, electric vehicles are subject to their own unique set of problems. For example, the range of an electric vehicle is often dependent upon the amount of charge that can be, or is, stored in a battery of that vehicle. This can be, and typically is, mitigated via the use of electric charging stations. In the case of an electric bus, such electric charging stations may be placed throughout a transit route that is traversed by the bus (e.g., at bus stops) to provide periodic recharging. Additionally, some electric vehicles may use recharging technology like regenerative braking to provide periodic recharging.

### SUMMARY

Techniques are provided herein for providing feedback to an operator of a vehicle (e.g., a driver) in real-time to optimize the operation of that vehicle. In some embodiments, the techniques may involve comparing driving data collected from the vehicle during its operation to expected (e.g., typical or optimal) driving behaviors to identify a variance between the two data. In some cases, a determination may be made as to whether the identified variance has a positive or negative impact on the operations of the vehicle. Upon detecting a variance (that has a negative impact on vehicle operations), the techniques may involve generating feedback that is then provided to the operator of the vehicle. Such feedback may include instructions determined to, if followed by the operator of the vehicle, have a positive impact on, or at least reduce the negative impact on, the vehicle operations.

In some embodiments, the techniques may include obtaining data from one or more sensors installed within a number of vehicles and generating expected driving behavior pattern data based on that sensor data. In some cases, the data may be associated with a geographic location at which the data was obtained. For example, expected driving behavior pattern data may be associated with an intersection that is generated by collecting and aggregating sensor data received from a plurality of vehicles that have traversed that intersection.

Sensor data may further be collected in real-time from one or more sensors installed within a vehicle that is being currently operated (e.g., driven). The sensor data collected from the vehicle may be analyzed to determine current driving patterns for an operator of the vehicle. Those current driving patterns may then be compared against the expected driving behaviors to determine a variance between the two. In some cases, a determination may be made as to whether the variance is correlated to a positive or negative impact on the operations of the vehicle. Feedback may be generated based on the determined variance and provided to the operator of the vehicle.

In one embodiment, a method is disclosed as being performed by a computing device that manages operations of a fleet, such as an operation optimization platform, the method comprising receiving, from a vehicle, operation data related to performance of one or more operations of the vehicle, obtaining expected operation data relevant to the vehicle, calculating a variance representing a difference between the between the operation data and the expected operation data, generating, based on the calculated variance, feedback to be provided to an operator of the vehicle, and providing the feedback to the vehicle to be presented to the operator.

An embodiment is directed to a computing system comprising a processor; and a memory including instructions that, when executed with the processor, cause the computing device to, at least receive, from a vehicle, operation data related to performance of one or more operations of the vehicle, obtain expected operation data relevant to the vehicle, calculate a variance representing a difference between the between the operation data and the expected operation data, generate, based on the calculated variance, feedback to be provided to an operator of the vehicle, and provide the feedback to the vehicle to be presented to the operator.

An embodiment is directed to a non-transitory computer-readable media collectively storing computer-executable instructions that upon execution cause one or more computing devices to collectively perform acts comprising receiving, from a vehicle, operation data related to performance of one or more operations of the vehicle, obtaining expected operation data relevant to the vehicle, calculating a variance representing a difference between the between the operation data and the expected operation data, generating, based on the calculated variance, feedback to be provided to an operator of the vehicle, and providing the feedback to the vehicle to be presented to the operator.

The foregoing, together with other features and embodiments will become more apparent upon referring to the following specification, claims, and accompanying drawings. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example computing environment in which operations of a fleet of electric vehicles may be optimized based on individual driving behaviors in accordance with at least some embodiments;

FIG. 2 illustrates a block diagram showing various components of an example system architecture that supports generation of feedback to optimize operation of electric vehicles in accordance with at least some embodiments;

FIG. 3 illustrates a flow chart of an example process by which behavior data is associated with a driver in accordance with at least some embodiments;

FIG. 4 depicts an example system implemented across a geographic area in accordance with at least some embodiments; and

FIG. 5 depicts a flow diagram showing an example process 500 for generating and providing feedback to the vehicle based on operation data received from the vehicle in accordance with at least some embodiments.

### DETAILED DESCRIPTION

This disclosure is directed towards a system that determines behaviors or other characteristics common to a group, or groups, of drivers and generates feedback in real-time for a current vehicle operator based on those characteristics. For example, sensor data received from one or more vehicles in the fleet of electric vehicles may be aggregated and used to determine expected (e.g., typical or optimal) driving behavior patterns to be associated with particular locations, transit routes, driving times, etc. Once such expected driving behavior patterns have been determined, sensor data collected in real time from a vehicle that is currently being operated may be compared to that expected driving behavior data.

If a variance is detected between expected driving behavior patterns and driving data for a current operator of a vehicle, feedback may be generated based on the detected variance. The feedback is then provided to the operator of the vehicle (e.g., via an output device, such as a display or speaker). In some embodiments, a determination is made as to whether the variance detected between the expected driving behavior patterns and driving data for the current operator is correlated to a positive or negative impact on aspects of the vehicle's operation (e.g., efficiency of battery charging/usage, safety, braking efficiency, etc.). In these embodiments, feedback may be generated and provided to the operator of the vehicle, for example, if a determination is made that the variance is correlated to a negative impact on the vehicle's operation.

In embodiments, the feedback may include instructions directed to the operator of the vehicle to perform certain actions. Such actions may be calculated to reduce a degree of the determined variance. For example, if a determination is made that the vehicle is traveling a determined amount faster than is expected at a location, then feedback may be generated to reduce the speed of the vehicle by the determined amount. In another example, a determination may be made that the operator of the current vehicle is not using regenerative braking features as is expected for a user at the vehicle's current location.

Embodiments of the disclosure provide numerous advantages over conventional systems. For example, it may be difficult for an operator of a vehicle to discern what sorts of operations can result in more efficient operation of a vehicle. For example, the operator of the vehicle may not understand under what circumstances s/he should activate a regenerative braking feature of the vehicle. The system disclosed herein enables feedback to be provided to an operator of a vehicle in real time as the operator performs actions. This allows the operator of the vehicle to be timely apprised of operations that s/he can take to more efficiently operate the vehicle.

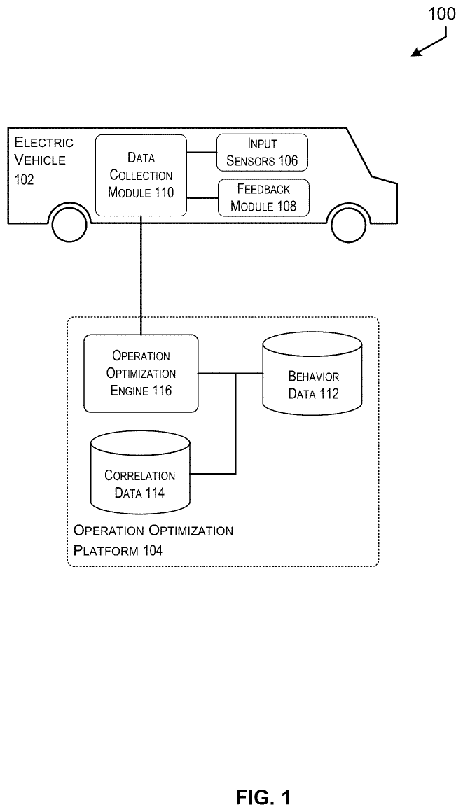

FIG. 1 illustrates a computing environment 100 in which operations of a fleet of electric vehicles may be optimized based on individual driving behaviors. In some embodiments, one or more electric vehicle 102 is in communication with an operation optimization platform 104. In some embodiments, the electric vehicle is in continuous or semi-continuous communication with the operation optimization platform via a wireless communication channel. In some embodiments, the electric vehicle may establish communication with the operation optimization platform upon arriving at particular access points (e.g., recharging stations and/or bus stops).

An electric vehicle 102 may include any suitable mode of transportation that operates primarily using electric current, e.g., using one or more electric motors to cause the electric vehicle to move. In some embodiments, electric current available to a particular electric vehicle may be limited based on a capacity of a battery or other electric storage medium. In some embodiments, the charge on a battery of the electric vehicle may be restored at least partially throughout a vehicle's operation. For example, in the case that the electric vehicle is a bus that makes stops along a route, the battery of the electric vehicle may be recharged at least partially each time that the bus positions itself over a wireless charging pad located at one of the bus stops. In another example, the electric vehicle may be configured to perform regenerative braking each time that the vehicle slows down or stops, which is an energy recovery mechanism that slows down a moving vehicle or object by converting its kinetic energy into a form that can be either used immediately or stored until needed (in this case, as battery charge).

In some embodiments, the electric vehicle may include one or more input sensors 106 configured to obtain information about an aspect of the vehicle. For example, input sensors may be installed within, or alongside, the vehicle brake pedal to determine how much pressure a driver applies to the brake pedal as well as for how long such pressure is applied. In another example, an input sensor may be installed within, or alongside, the vehicle steering wheel to collect and provide information on a how the steering wheel is rotated during turns.

Additionally, the electric vehicle may include a feedback module 108 that is configured to provide feedback generated by the operation optimization platform to an operator (e.g., driver) of the vehicle. In some embodiments, the feedback module may convey feedback generated by the operation optimization platform to one or more output devices. For example, feedback received by the feedback module may be conveyed to the operator of a vehicle via visual information presented on a display, and/or audio information presented on speakers, installed within the vehicle.

Data obtained from the input sensors may be provided to a data collection module 110 to be processed and provided to the operation optimization platform. In some embodiments, behavior data may be identified based on the sensor data received from the input sensors. In some embodiments, sensor data received from a particular input sensor may be compared to sensor data received under similar circumstances. For example, sensor data received from a sensor installed in communication with a steering wheel that is collected at a particular location may be compared to sensor data received in relation to steering wheel information received from other vehicles/drivers at that particular location. In this example, variances between the compared steering wheel data may be used to generate feedback as described herein.

The operation optimization platform 104 may include any computing device or combination of computing devices configured to perform at least a portion of the functionality described herein. Operation optimization platform may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Operation optimization platform can include one or more virtual machines running virtual operating systems, or other computing architectures involving virtualization such as one or more flexible pools of logical storage devices that can be virtualized to maintain virtual storage devices for the computer.

The operation optimization platform 104 may be configured to generate feedback for a vehicle operator that is calculated to result in optimization of vehicle operations. In some embodiments, the operation optimization platform may be configured to maintain behavior data 112 generated from a plurality of drivers. The behavior data may include information that has been aggregated about trends or patterns identified in relation to behaviors displayed by the plurality of drivers. In some embodiments, the behavior data is associated with a particular location or vehicle operation. In some embodiments, the vehicle may belong to a fleet of vehicles and the behavior data may include data associated with expected driving behavior of drivers within the fleet of vehicles. In some embodiments, the vehicle may be assigned to a route (e.g., a public transit route or a delivery route) and the behavior data may include data associated with expected driving behavior of drivers that operate on the route.

In some embodiments, the operation optimization platform may include information indicating either a positive or negative correlation between particular driving behaviors and optimization of a vehicle operation (e.g., correlation data 114). In some cases, such correlations may be determined by assessing one or more vehicle attributes at particular times. For example, in the case in which the vehicle is assigned to a transit route, information about a charge and/or charge capacity of the vehicle's battery pack may be measured at both the beginning of the transit route and at the end of the transit route. In this example, the difference in measurements from each of the two points in time may be compared to an average difference in measurements to determine whether the driver performed better or worse than the average driver on that transit route. In this example, a user, such as an administrator, may indicate whether the difference in measurements impacts vehicle operations in a positive or negative manner (e.g., whether the difference is good or bad). Once such a determination has been made, driving behaviors (and particularly variances between driving behaviors of the operator and expected driving behaviors) may be identified with respect to the vehicle operator over the course of the transit route and may subsequently be assigned the respective positive or negative correlation.

Within an operation optimization platform, an operation optimization engine 116 may be configured to receive current vehicle operation data generated by a data collection module within the vehicle, identify a variance between the current vehicle operation data and expected driving behavior data (e.g., from behavior data 112). In some embodiments, the operation optimization engine may be configured to determined whether the variance is correlated to a positive or negative impact on one or more vehicle operations. The operation optimization engine may be further configured to generate feedback directed to an operator of the vehicle based on the identified variance. It should be noted that a variance, for the purposes of this disclosure, may represent any distinction that can be drawn between two data sets. In some embodiments, a variance may be detected if the degree of such a distinction exceeds a predetermined threshold value. In some cases, such a threshold value may represent a portion or percentage of data values within at least one of the data sets.

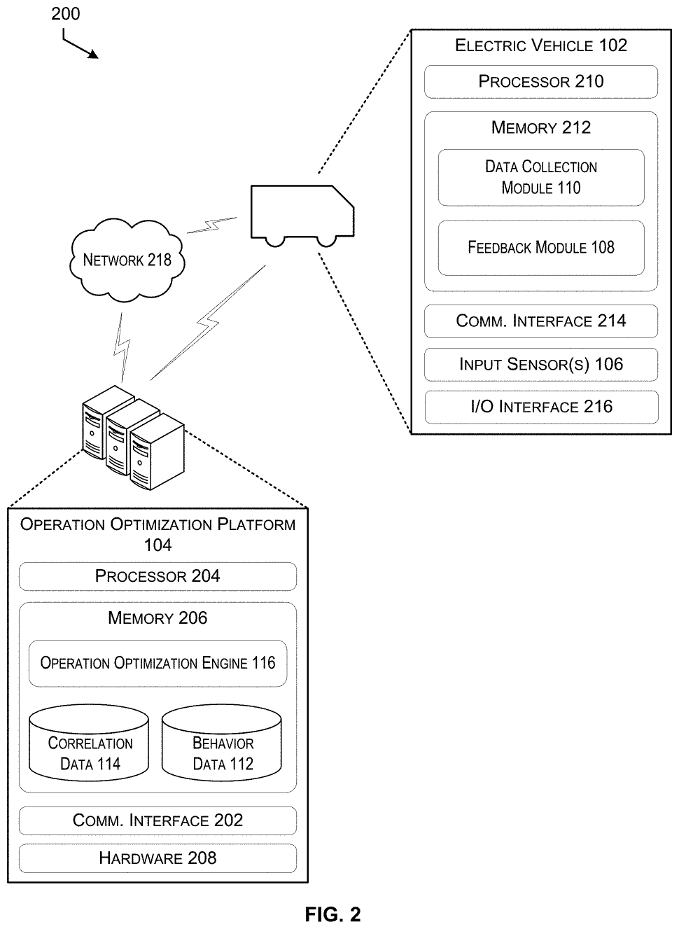

FIG. 2 illustrates a block diagram showing various components of a system architecture that supports generation of feedback to optimize operation of electric vehicles in accordance with some embodiments, for example, to reduce the vehicle's utilization of electrical energy compared to the utilization without the benefit of such feedback. As used herein, optimization may include maximization and/or minimization of an operating parameter and/or set of parameters. Such maximization and/or minimization need not be absolute, for example, the optimization may substantially maximize and/or minimize the parameters and/or set of parameters. Alternatively, or in addition, optimization may result in a configuration (e.g., a parameter and/or set of parameters) being more optimal compared to the configuration not subject to feedback. The system architecture 200 may include an operation optimization platform 104 may be in communication with one or more electric vehicles 102.

As noted above, an operation optimization platform 104 can include any computing device configured to perform at least a portion of the operations described herein. The operation optimization platform 104 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The operation optimization platform 104 can include one or more virtual machines running virtual operating systems, or other computing architectures involving virtualization such as one or more flexible pools of logical storage devices that can be virtualized to maintain virtual storage devices for the computer. For example, the operation optimization platform 104 may include virtual computing devices in the form of virtual machines or software containers that are hosted in a cloud.

The operation optimization platform 104 may include a communication interface 202, one or more processors 204, memory 206, and hardware 208. The communication interface 202 may include wireless and/or wired communication components that enable the operation optimization platform 104 to transmit data to and receive data from other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the operation optimization platform 104 may implement functionality that includes one or more software modules and data stores. Such software modules may include routines, program instructions, objects, and/or data structures that are executed by the processors 204 to perform particular tasks or implement particular data types. More particularly, the memory 206 may include at least a module that is configured to generate feedback calculated to optimize operation of at least one vehicle. Additionally, the operation optimization platform may include a number of data stores that include information that may be used by the operation optimization platform to optimize operations of the fleet. For example, the operation optimization platform may include a database of information on correlations between driving behaviors and operation optimizations (e.g., correlation data 114), a database of information on learned driver behavior data (e.g., behavior data 112).

An operation optimization engine 118 may be configured to, in conjunction with the processor 204, generate feedback to be provided to an operator of a vehicle to cause optimization of one or more operations of that vehicle. By way of some non-limiting examples, optimization of vehicle operations may include increasing the efficiency of battery/fuel usage, increasing charging efficiency, or increasing the operator use of operational features, such as regenerative braking. In some embodiments, the operation optimization engine may receive current driving behavior data from a vehicle that is being operated. Driving behavior data may include any suitable indication of one or more actions taken by an operator of the vehicle and/or a degree to which actions are taken. For example, the driving behavior may indicate a ratio of regenerative braking used by the operator to regular braking. In another example, the driving behavior may indicate a degree or amount of pressure that the operator applies to a pedal or the steering wheel. In some embodiments, behavior data may be represented as numeric values. Additionally, the operation optimization engine may receive location information (e.g., Global Positioning System (GPS) data) to be associated with the received driving behavior data.

The operation optimization engine may retrieve expected driving behavior data (e.g., from behavior data 112) to be compared against the received current driving behavior data. Such expected driving behavior may indicate information obtained from a plurality of vehicle operators that has been averaged or otherwise adjusted to be representative of driving behavior data collected from that plurality of vehicle operators. The retrieved expected driving behavior may be associated with a location (e.g., the same location as is associated with the received driving behavior). The operation optimization engine may subsequently calculate a variance between the received current driving behavior data and the retrieved expected driving behavior. In some cases, once a variance has been calculated, a determination may be made as to whether the variance is positively or negatively correlated to optimization of one or more operations of the vehicle (e.g., via correlation data 114). Upon detecting a variance between the data sets (and in some cases upon determining that the variance is negatively correlated to optimization of vehicle operations), the operation optimization engine may generate feedback to be provided to the operator of the vehicle.

Feedback generated by the operation optimization engine may pertain to any suitable operation performed or performable by an operator of the vehicle. Such feedback may include instructions to perform, cease performing, increase performance of, or decrease performance of, one or more operations. The feedback generated by the operation optimization engine may be calculated to result in a reduction of the variance between the two data sets. The generated feedback may be provided to the vehicle as it is generated.

A noted elsewhere, an electric vehicle 102 may comprise any suitable vehicle that is primarily powered using electrical current. In addition to including various components required to enable transit, the electric vehicle includes one or more processors 210, a memory 212, a communication interface 214, one or more input sensors 106, and an input/output interface 216.

The one or more processors 210 and the memory 212 of the operation optimization platform 104 may implement functionality that includes one or more software modules and data stores. Such software modules may include routines, program instructions, objects, and/or data structures that are executed by the processors 210 to execute one or more functions of the electric vehicle. More particularly, the memory 212 may include at least a module that is configured to facilitate the collection of user driving data (e.g., data collection module 110) and a module for providing received feedback to a current driver of the electric vehicle (e.g., feedback module 108).

A data collection module 110 may be configured to, in conjunction with the processor 210, determine driver behavior to be associated with the current driver of the electric vehicle. The data collection module may receive input sensor data from a number of different input sensors installed within the vehicle, each of which may be in communication with a component of the electric vehicle (e.g., brake pad, gas pedal, steering wheel, et.). The input sensor data may include information about the activation or use of the component with which it is in communication. In some embodiments, the input sensor data may indicate a degree or strength to which a component has been activated. The data collection module may record times and/or locations at which various sensor readings are received during the operation of an electric vehicle.

A feedback module 108 may be configured to, in conjunction with the processor 210, provide feedback generated by the operation optimization platform to an operator (e.g., driver) of the vehicle. In some embodiments, the feedback module may receive feedback from the operation optimization platform in real-time (e.g., as the vehicle is being operated) and may convey that feedback to one or more output devices to be presented to the operator. Particularly, the feedback module may be configured to convey the received feedback to the operator of a vehicle via visual information presented on a display, and/or audio information presented on speakers, installed within the vehicle.

In some embodiments, the feedback generated by the operation optimization platform may include instructions to be executed automatically (e.g., without human interaction) by one or more mechanical components of the vehicle. In such embodiments, the one or more mechanical components of the electric vehicle may be configured to execute instructions received from the operation optimization platform. In these embodiments, the electric vehicle may receive instructions that, when executed, cause one or more components of the electrical vehicle to be adjusted or to perform an operation. For example, the electric vehicle may receive instructions that, when executed, cause a sensitivity of the vehicle's brake pad or gas pedal to be adjusted (e.g., by adjusting the pressure of a hydraulic line). In another example, a sensitivity of the steering wheel may be adjusted so that a turning radius of the electric vehicle is either increased or decreased for an amount of rotation applied to the steering wheel.

As noted elsewhere, the operation optimization platform may be configured to communicate with one or more electric vehicle. Such communication may be enabled via any suitable wired or wireless communication means. In some embodiments, the operation optimization platform may be configured to communicate with the electric vehicle directly via a short-range wireless communication means. In some embodiments, the operation optimization platform may be configured to establish communication with the electric vehicle over a network 218.

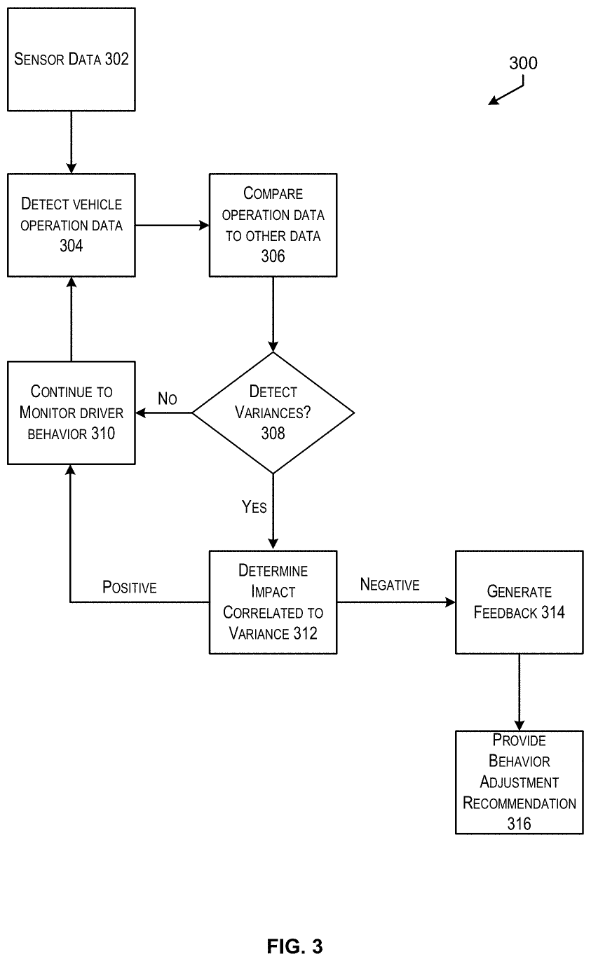

FIG. 3 illustrates a flow chart process by which behavior data is associated with a driver in accordance with at least some embodiments. The process 300 involves a number of interactions between various components of the computing environment described with respect to FIG. 1. In some embodiments, a communication session may be established between a vehicle and an operation optimization platform.

At 302, the process 300 comprises receiving sensor data from a number of input sensors installed within an electric vehicle. In some cases, one or more of the input sensors may be in communication with components of the electric vehicle. In these cases, the input sensor data may be received each time that the respective component is activated. In some cases, one or more of the input sensors may collect information about the electric vehicle and/or an environment in which the electric vehicle is located. For example, input sensors may include a GPS device that collects location data for the electric vehicle, a thermometer that collects temperature information, a magnetometer that collects orientation information, or any other suitable sensor device. In some embodiments, the sensor data may be received continuously from one or more of the input sensors installed in the vehicle.

At 304, the process 300 comprises detecting operation data (e.g., driver behavior data) based on the received sensor data. In some embodiments, operation data may be detected upon interpreting the received sensor data. For example, upon detecting, such as from GPS sensor data, that the vehicle's location is changing, a determination may be made that the vehicle is in transit. In this example, a speed and direction of the vehicle may also be determined. In another example, upon receiving information from an input sensor in communication with a brake pad included in the vehicle, a determination may be made that the vehicle is braking. Upon detecting vehicle operations as interpreted from the received input sensor data, those vehicle operations may each be associated with times and locations as detected from location data that is also received at the time that the sensor data is received.

At 306, the process 300 comprises comparing the detected operation data against other operation data to identify variances and/or similarities between that operation data. In some embodiments, the operation data received from the vehicle may be compared to operation data received from a number of different vehicles. In some embodiments, current vehicle operation data associated with a particular location may be compared to operation data that is associated with the same location for the number of different vehicles.

In some embodiments, a baseline of operation data may be generated as expected driving behavior. Such a baseline of operation data may be generated by aggregating operation data received at different times and/or from different vehicles. In some embodiments, baseline operation data may be generated for each of a number of locations by aggregating operation data from a number of vehicles that is associated with the respective locations. Such operation data may comprise operation data received with respect to a plurality of vehicles that may also include the same vehicle (e.g., during previous operations). A baseline of operation generated for a location may include any suitable indication of operations that are typically performed at the location. For example, the baseline operation data may include an indication of a speed at which vehicles typically move at the location, braking patterns typically used at the location, acceleration patterns typically used at the location, or any other suitable operation data.

At 308, the process 300 may comprise determining one or more variances between the operation data and baseline operation data. In some embodiments, variances may be determined based on a degree to which the operation data determined from the received sensor data matches the operation data to which it is compared (e.g., other operation data or a baseline operation data). Such variances may comprise an indication of differences between the current driver's actions in relation to expected driver actions. For example, variances may include an indication of a difference between the current driver's speed in operating the vehicle in relation to typical drivers' speed. In another example, a determined variance may include an indication of a difference between the current driver's use of operational features (e.g., regenerative braking, etc.) in relation to typical drivers' use of those features. In some embodiments, driver behavior patterns may be determined based on the variances detected between the detected operation data and the operation data to which it has been compared. For example, a driver behavior pattern may be detected that indicates that the driver is driving, or has a tendency to drive, at a relatively high speed upon determining that the current operation data indicates a speed of travel that is higher than that of a baseline operation data.

In some embodiments, a detected variance may be determined based on a combination of operation data. For example, if information received from a vehicle indicates that the steering wheel has been rotated to a determined degree, and that the vehicle is traveling at a determined speed, then a variance may be detected based on both of those factors. In this example, a determination may be made that the determined speed of the vehicle is above or below the average speed that drivers typically make a turn associated with the determined degree of rotation.

In some cases, variances may only be identified if a difference between the two operational data exceeds a predetermined threshold. Upon failing to identify variances to be associated with vehicle operation (e.g., “No” from decision block 308), the process 300 comprises continuing to monitor operation data for variances at 310.

Upon detecting one or more variances (e.g., “Yes” from decision block 308), the process 300 may, in some embodiments, comprise determining an impact correlated to the detected variance at 312. In some cases, a determination is made as to whether that impact of the variance correlates positively or negatively to optimization of one or more operations of the vehicle, e.g., with respect to efficiency and/or effectiveness of the operation(s) and/or the vehicle. If a determination is made that the impact of the variance correlates positively to optimization of one or more operations (e.g., “positive” from decision block 312), the process 300 comprises continuing to monitor operation data for variances at 310.

If a determination is made that the impact of the variance correlates negatively to optimization of one or more operations (e.g., “negative” from decision block 312), or upon detecting at least one variance in embodiments in which no correlation is determined, the process 300 comprises generating feedback to be provided to an operator of the vehicle at 314. To generate feedback, a driving behavior or operation may be identified as being associated with the variance in operation data. For example, if the variance relates to a speed of the vehicle in operation, then a driving behavior may be identified as driving over/under the speed limit (or at least an average speed that vehicles travel at that location). Instructions may then be generated that are directed to the identified driving behavior and that are calculated to reduce the variance between the operation data sets.

As noted elsewhere, in some cases generated feedback may include instructions to be executed by one or more mechanical components of the vehicle. For example, the feedback may include instructions that, when executed, cause the one or more mechanical components to activate, deactivate, or to be adjusted.

At 316, the process 300 comprises providing the generated feedback to the vehicle to be presented to the operator of that vehicle. The provided feedback may be transmitted wirelessly to the vehicle via an active communication session between the vehicle and the operation optimization platform.

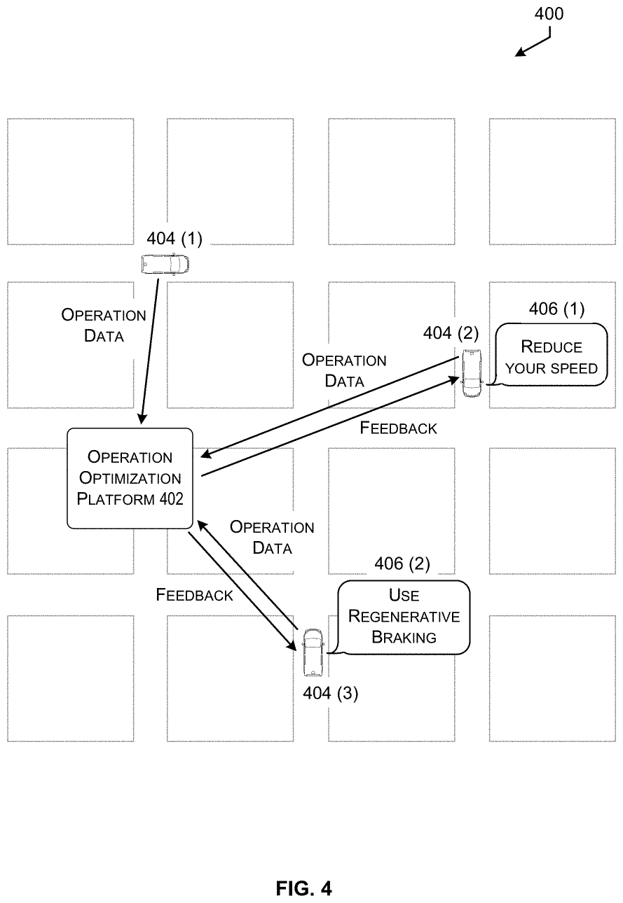

FIG. 4 depicts an exemplary system implemented across a geographic area in accordance with embodiments. In the system 400, an operation optimization platform 402 may be in communication with a number of vehicles 404 (1-3) located throughout a geographic region. Such communication may occur via a wireless communication session established between a vehicle and the operation optimization platform.

In the system 400, each of the vehicles 404 (1-3) may provide current operation data to the operation optimization platform. As described elsewhere, such operation data may be generated from sensor data obtained from sensors installed within the respective vehicle. The operation data provided to the operation optimization platform is used to generate feedback, which is then provided to the respective vehicle in real time. Processes for generating such feedback are described elsewhere.

Feedback provided to a vehicle may include a message 406 (1-2) intended for presentation to an operator of that vehicle, instructions to be executed by one or more mechanical components of the vehicle, or some combination. For example, if the operation optimization platform determines that a vehicle is traveling faster than is typical within an area, feedback may be generated that includes a message 406 (1) to the operator to “reduce your speed,” as well as instructions to cause a sensitivity of the vehicle's gas pedal to be reduced.

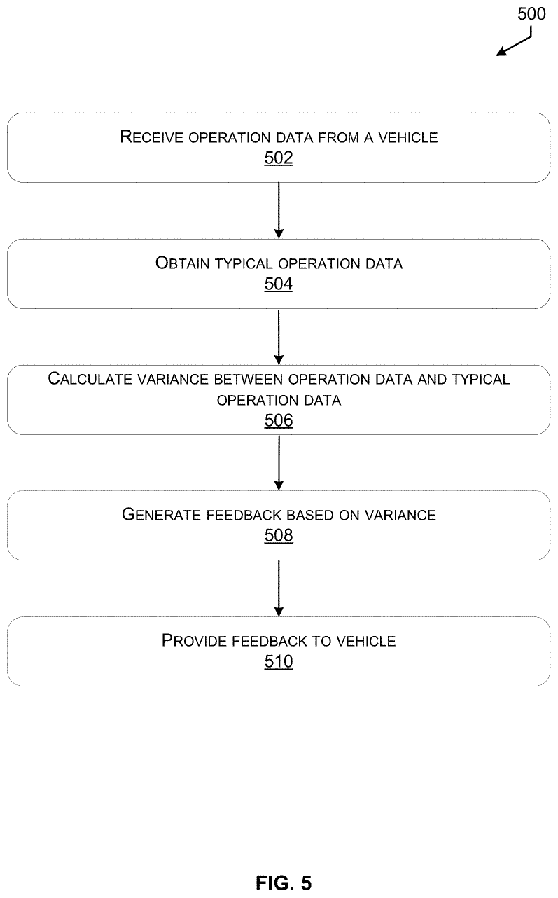

FIG. 5 depicts a flow diagram showing an example process flow 500 for generating and providing feedback to the vehicle based on operation data received from the vehicle in accordance with embodiments. The process 500 may be performed by a computing device that is configured to generate and provide a product strategy for a product. For example, the process 500 may be performed by an operation optimization platform, such as the operation optimization platform 104 described with respect to FIG. 1 above.

At 502, the process 500 comprises receiving operation data from a vehicle. As noted elsewhere, the operation data may be received from one or more sensors installed within the vehicle. For example, input sensors may be installed within, or alongside, the vehicle brake pedal to determine how much pressure a driver applies to the brake pedal as well as for how long such pressure is applied. In another example, an input sensor may be installed within, or alongside, the vehicle steering wheel to collect and provide information on a how the steering wheel is rotated during turns.

At 504, the process 500 comprises obtaining expected operation data determined to be relevant to the vehicle. In some embodiments, the expected operation data relevant to the vehicle is generated from operation data received from a plurality of vehicles. In some cases, the operation data received from a plurality of vehicles comprises operation data associated with a current location of the vehicle. For example, expected operation data may be generated by aggregating, and in some cases averaging, operation data received from a plurality of other vehicles at that location. In some cases, the operation data received from a plurality of vehicles comprises operation data associated with the one or more operations of the vehicle. For example, the operation data may be generated by aggregating, and in some cases averaging, operation data received from a plurality of other vehicles that have performed the same operations as the current vehicle. By way of non-limiting example, the performance of the one or more operations of the vehicle may include at least one of driving the vehicle, braking the vehicle, or steering the vehicle.

At 506, the process 500 comprises calculating a variance between the operation data and the obtained expected operation data. In some embodiments, such a variance may only be recognized if it exceeds a threshold value. In some cases, the threshold value comprises a portion or percentage of the one or more data values in the operation data. In some cases, the threshold value comprises a predetermined value based on the one or more operations.

In some embodiments, the process further comprises determining an impact that the calculated variance is likely to have on optimization of one or more vehicle operations. In these embodiments, the feedback is generated upon making a determination that the calculated variance is likely to have a negative impact on the optimization of one or more vehicle operations.

At 508, the process 500 comprises generating feedback based on the calculated variance. As noted elsewhere, the feedback may include a message to be presented to the operator of the vehicle, the message predicted to result in a reduction of the calculated variance. In some embodiments, the feedback further comprises instructions to be executed by one or more mechanical components of the vehicle. In such embodiments, the instructions may cause a sensitivity of the vehicle's brake pad or gas pedal to be adjusted or a sensitivity of the steering wheel to be adjusted.

At 510, the process 500 comprises providing the generated feedback to the vehicle to be presented to an operator of that vehicle. As noted elsewhere, the feedback is presented to the operator via an output device installed in the vehicle. Such an output device may include a speaker or a display device.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving, from an electric vehicle, operation data related to performance of one or more operations of the electric vehicle;
obtaining expected operation data relevant to the electric vehicle;
calculating a variance representing a difference between the between the operation data and the expected operation data;
generating, based on the calculated variance, feedback to be provided to an operator of the electric vehicle, the feedback configured to reduce utilization of electrical energy by the electric vehicle; and
providing the feedback to the electric vehicle to be presented to the operator.

2. The method of claim 1, wherein the feedback is presented to the operator via an output device installed in the electric vehicle.

3. The method of claim 2, wherein the output device comprises at least one of a speaker or a display device.

4. The method of claim 1, wherein the operation data is received from one or more sensors installed within the electric vehicle.

5. The method of claim 1, further comprising determining an impact that the calculated variance is likely to have on optimization of one or more electric vehicle operations, wherein the feedback is generated upon making a determination that the calculated variance is likely to have a negative impact on the optimization of the one or more electric vehicle operations.

6. The method of claim 1, wherein the expected operation data relevant to the electric vehicle is generated from operation data received from a plurality of electric vehicles.

7. The method of claim 6, wherein the operation data received from a plurality of electric vehicles comprises operation data associated with a current location of the electric vehicle.

8. The method of claim 6, wherein the operation data received from a plurality of electric vehicles comprises operation data associated with the one or more operations of the electric vehicle.

9. The method of claim 1, wherein the feedback is generated upon determining that the calculated variance exceeds a threshold value.

10. A computing device comprising:
a processor; and
a memory including instructions that, when executed with the processor, cause the computing device to, at least:
receive, from a vehicle, operation data related to performance of one or more operations of the vehicle;
obtain expected operation data relevant to the vehicle;
calculate a variance representing a difference between the between the operation data and the expected operation data;
generate, based on the calculated variance, feedback to be provided to an operator of the vehicle; and
provide the feedback to the vehicle to be presented to the operator.

11. The computing device of claim 10, wherein the performance of the one or more operations of the vehicle comprises at least one of driving the vehicle, braking the vehicle, or steering the vehicle.

12. The computing device of claim 10, wherein the further cause the computing device to determine whether the calculated variance exceeds a threshold value, wherein the feedback is generated if the calculated variance does exceed the threshold value.

13. The computing device of claim 12, wherein the threshold value comprises a portion or percentage of the one or more data values in the operation data.

14. The computing device of claim 12, wherein the threshold value comprises a predetermined value based on the one or more operations.

15. The computing device of claim 10, wherein the feedback comprises a message to be presented to the operator of the vehicle, the message predicted to result in a reduction of the calculated variance.

16. The computing device of claim 10, wherein the feedback further comprises instructions to be executed by one or more mechanical components of the vehicle.

17. The computing device of claim 16, wherein the instructions cause a sensitivity of the vehicle's brake pad or gas pedal to be adjusted or a sensitivity of the steering wheel may be adjusted.

18. A non-transitory computer-readable media collectively storing computer-executable instructions that upon execution cause one or more computing devices to collectively perform acts comprising:
receiving, from a vehicle, operation data related to performance of one or more operations of the vehicle;
obtaining expected operation data relevant to the vehicle;
calculating a variance representing a difference between the between the operation data and the expected operation data;
generating, based on the calculated variance, feedback to be provided to an operator of the vehicle; and
providing the feedback to the vehicle to be presented to the operator.

19. The non-transitory computer-readable media of claim 18, wherein the operation data is received from one or more sensors installed within the vehicle.

20. The non-transitory computer-readable media of claim 18, wherein the feedback comprises a message to be presented to the operator of the vehicle, the message predicted to result in a reduction of the calculated variance.
